(19) United States
(12) Patent Application Publication
(10) Pub. No.: US 2025/0322088 A1
(43) Pub. Date: Oct. 16, 2025

(54) Analytical AI Auto-Locking Apparatus, System, and Method for Preventing Unauthorized File Access

(71) Applicant: Zafar Khan, Redondo Beach, CA (US)

(72) Inventor: Zafar Khan, Redondo Beach, CA (US)

(21) Appl. No.: 19/177,298

(22) Filed: Apr. 11, 2025

Related U.S. Application Data
(60) Provisional application No. 63/632,975, filed on Apr. 11, 2024.

(51) Int. Cl. G06F 21/62; G06F 21/57

(52) U.S. Cl. CPC G06F 21/6209; G06F 21/577; G06F 2221/2141

(57) ABSTRACT

Cybercriminals are using advanced techniques to access information not only inside a company network but outside of a company network in the ecosystem of company communications with customers, suppliers, partners, and professional advisors. There are many ways cybercriminals gain access to this information, often by compromising email accounts, archives, and document management systems outside of a company's own control and/or outside of their control to manage security of those external accounts. This invention provides an apparatus that will proactively detect when a cybercriminal has accessed or is attempting to access a document attached to an email, a document stored in a repository, a link to an e-signature transaction, a link to a file download (“Files”), and pre-emptively auto-lock the attempted-to-be-eavesdropped on Files and alert the File owner of a high risk information breach in progress, even if that breach is outside their network or information perimeter.

### FIELD

This invention relates to the field of Information Rights Management (IRM), specifically in the subsectors of Electronic Digital Rights Management (EDRM), its subsectors of Electronic Document Rights Management, Document Security, Enterprise Output Management (EOM), Secure File Sharing (SFS), and Digital Transaction Management (DTM) software and systems as they relate to cybersecurity threats of Business Email Compromise and Ransomware attacks, using cybercriminal methods including Email Account Compromise among others.

### BACKGROUND

Cybersecurity researchers have identified Al bots exclusively designed for criminal activities, configured to craft email and SMS phishing messages, generate “deep fakes” and “voice replication” to effectively impersonate banks and other financial organizations and their staff, among other tactics. By using these generative Al tools, a cybercriminal can also easily craft enticing emails to scale, thereby luring recipients into clicking a malicious link-crucial for mass and targeted email phishing campaigns.

Before generative Al tools were released or widely adopted by cybercriminals, there was already $2.9 billion in reported losses reported in the US in 2023 due to Business Email Compromise (BEC) attacks, a 10% increase from 2022. However, the FBI estimates this is vastly underreported because usually only 20% of victims report to the FBI. Further, BEC scams have been reported in all 50 states and 177 countries around the world with cybercriminals sending fraudulent or stolen funds to over 140 countries, according to the 2023 FBI IC3 Report.

BEC scams are perpetrated mostly by Email Account Compromise (EAC). This invention automatedly identifies and proactively pre-empts this kind of cyberattack. Per the FBI, once BEC perpetrators gain access to a participant's email account involved in a real estate transaction, for example, they are able to monitor the real estate proceeding and often time the fraudulent request for a change in payment type (frequently from check to wire transfer) or a change from one bank account to a different bank account under their control.

From calendar years 2020 to 2022, there was a 27% increase in victim reports to the IC3 of BECs with a real estate nexus. In this same time frame, there was a 72% increase in victim loss of BECs with a real estate nexus. The increases in victim losses from BEC with a real estate nexus are notable with the increase in victim reporting and also may be contributed to the rise in real estate costs over the last several years. In 2022, there were reported actual losses of $446 Million related to real estate transactions in the USA. Real estate losses account for approximately 16% of the total losses based on the reported 2022 figures, meaning, approximately 84% of the losses are in other business sectors beyond real estate.

Business Week, through a US Secret Service source, reported the US Secret Service summarized that the average loss is $150,000 per incident for BEC, with about one complaint filed every 37 seconds (but this includes not only losses but complaints of losses).

Based on the financial data reported to the IC3 for 2022, banks located in Hong Kong and China were the primary international destinations of fraudulent funds. These were followed by the United Kingdom (which often acts as an intermediary stop for funds), Mexico, and Singapore.

However, of significance, the US and UK account for 95% of the world's complaints reported to authorities. Although complaint types are not limited to phishing-related BEC lures, phishing related to BEC accounts for 58% of the complaints in the USA. Although the number of complaints in the UK is 50% of that in the US, this is a disproportionate number of complaints per capita, indicating this is a major issue in the UK.

In Email Account Compromise, the email account itself that may be in an organization separate from the sender organization has been compromised with the cybercriminal able to access, view and manipulate all of the content in the inbox. Email Account Compromise is a primary vector for cybercriminals to access documents, files, messages, and links to sensitive transactions. Thus, what is needed is an invention that can auto-lock these files if attempted to be accessed and ideally before accessed, in a compromised email account.

Notably, once the cybercriminal has access to the email account, they can access sensitive information even if it was sent encrypted to that recipient email account. They can, in many cases, defeat multi-factor email related authentication techniques and can often reset account passwords, which can give cybercrimes expansive access to information and systems.

Therefore, in addition to the importance of pre-empting a cybercriminal from eavesdropping on a particular document, message, or file that can provide information to the cybercriminal to plan their attack, knowledge for the information owner or the account owner that an email account that they sent information to, for instance, a colleague, customer, supplier, partner, advisor, has had their email account compromised will help provide early mitigation efforts before the cybercriminal can fully orchestrate their plan. With the email account compromise often occurring at the end of the recipient-who the information owner is sending information to-the invention is important in not only protecting the owner's information, but also in empowering them to protect the ecosystem of colleagues who they communicate with.

Additionally, the National Institute of Standards and Testing (NIST) has promoted the cybersecurity concept of “Zero Trust”. With cybercriminals now using Generative AI to access information that they then use to plan and hyper-target their attacks, this NIST-promoted security concept of Zero Trust is important. Zero Trust means that one can no longer implicitly trust assets, contracts, or user accounts based solely on their physical or network location, PDF format (even if digitally signed and securely stored), or asset ownership. One needs to add security layers that can detect anomalous or high risk activities at the user account (e.g. email account compromise) or asset level (e.g. cybercriminal attempt to access a File), regardless as to whether that File or user is inside a secure organization or system.

For example, if a cybercriminal has compromised an email account, they can generally reset passwords for many applications, or bypass multi-factor email authentication means for secure file sharing.

The present invention provides for a system and method of detecting such anomalous or high risk activities at the user account (e.g., email account compromise) or asset level (e.g. cybercriminal attempt to access a File), regardless of whether that File or user is inside a secure organization or system.

Other technologies and systems look for anomalies inside one's network (e.g., firewalls), on raw transaction data (e.g., credit card payment authorization), on inbound emails coming into an email account (e.g., anti-virus or anti-phishing), or may scan message content inside an inbox for viruses, malicious links, or spam. However, these systems do not protect the sender or owner of information sent to external recipients where the email account compromise is at that recipient's end, and thus outside of their system, firewall or controls.

This invention therefore provides a unique way of providing additional security layers that proactively can pre-empt, in an automated manner, loss of information due to cybercriminal eavesdropping on an email account, archive, eSignature transaction for file share exchange.

### SUMMARY OF THE INVENTION

According to a first aspect of the invention, a system for auto-locking a document is provided, said system comprising an auto-lock apparatus communicatively connected to an information asset application and a risk analyzer application; wherein the auto-lock apparatus is configured to: (i) receive raw transaction metadata associated with an information asset identifier from the information asset application; (ii) store the identifier with raw transaction metadata; and (iii) transmit the identifier with the raw transaction metadata to the risk analyzer application; the risk analyzer application is configured to: (i) receive an identifier with the raw transaction metadata from the auto-lock apparatus; (ii) generate an overall risk score based on the raw transaction metadata; and (iii) transmit the information asset identifier with an overall risk score to the auto-lock apparatus; and the auto-lock apparatus is further configured to transform the overall risk score into access instructions related to the information asset for transmittal to the information asset application.

According to a second aspect of the invention, a method for auto-locking a document, including the steps of: (i) transmitting raw transaction metadata associated with an information asset identifier from an information asset application to an auto-lock apparatus; (ii) storing the information asset identifier with the raw transaction metadata in the auto-lock apparatus; (iii) transmitting the information asset identifier with the raw transaction metadata from the auto-lock apparatus to a risk analyzer; (iv) generating an overall risk score based on the raw transaction metadata; (v) transmitting the information asset identifier with an overall risk score from the risk analyzer to the auto-lock apparatus; (vi) translating the overall risk score into actionable access instruction, namely to lock or unlock the information asset; (vii) transmitting the access instructions from the auto-lock apparatus to the information asset application.

According to a third aspect of the invention, an auto-lock apparatus for facilitating automated file access locking based on risk signals, said apparatus comprising: a receiving module configured to receive raw transaction metadata from document applications; a transmitting module configured to transmit the received raw transaction metadata to a data risk and eavesdropping analyzer application; a risk receipt module configured to receive risk metadata from the data risk and eavesdropping analyzer application; and an instructions module configured to transmit end user access denial instructions upon determination of a high-risk level based on the risk metadata.

### DETAILED DESCRIPTION OF THE INVENTION

This invention teaches an apparatus, system and method for using information derived from complex analysis of data associated with document, file, link, transaction, and/or message (“File”) access. This information is compared to external and everchanging data sets to provide an indication and pro-actively auto-lock access to information when the system, through data analysis, detects anomalous activity indicative of an unauthorized user attempting to access the information in document viewing, document management and File archiving, sharing, eSignature managing, link-retrieval and other applications. An objective of the present invention is to pre-empt an information breach.

This invention relates to information assets that are related to email, documents, file sharing, and email with links to subsequent processes like eSignature transactions or other similar (“Files”). Email may include any electronic message transmission including SMTP based electronic mail, SMS, MMS, WhatsApp, or other message transmission services. Document may include any document sharing or transfer service, and file service with rights protections, or multimedia file. The invention is an apparatus that is associated these types of transactions.

The invention relates to the RDocs document rights management service described in non-provisional U.S. patent application Ser. No. 18/134,480. However, one skilled in the art will understand how this may relate to other types of file share, eSign, and other services where the viewing of data is interacting with data in a way that transmits raw transaction metadata about the viewer or attempted viewer to the information asset application in the process of that application providing access or delivering the information asset to the viewer (“Files”).

An embodiment that incorporates inventions described in patent applications related to detecting email eavesdropping (non-provisional U.S. patent application Ser. No. 18/124,419, herewith incorporated by reference in its entirety), and document rights management and controls (non-provisional U.S. patent application Ser. No. 18/134,480, herewith incorporated by reference in its entirety), is as follows:

If a link is clicked to download a file, open a web page (e.g., e-sign request, disappearing ink, redacted email content, message-level attachment), or to view a rights controlled document (RDocs), before the file/page/document request is completed, information related to the File access request is transmitted to an apparatus. This apparatus pauses the File access temporarily until the apparatus performs an intermediate process of (a) receiving the IP, User Agent, HTTP Referrer, HTTP Language, and other HTTP, SMTP, SMS and protocol exchange information (“Raw Transaction Metadata”), (b) comparing the information against third party data sets to provide additional data related to the Raw Transaction Metadata, including information such as access information related to the Raw Transaction Metadata including one or more of geo-location, access IP type (VPN, Content Delivery Networks, VPN anonymizer Network), IP known reputation (e.g., score or assessment of nefarious use of the IP address), accessing device type (e.g., mobile, server, script), accessing device default language), network name, and more (“Transaction Metadata Insights”), and then (c) compares the Raw and Insights transaction metadata against a third set of data. The third set of data may comprise a user or organizations expectations for low and high risk activities based on the Raw or Insights Metadata, wherein the third set compares expected versus anomalous activity (“Risk Metadata”). This apparatus is explained in more detail in non-provisional U.S. patent application Ser. No. 18/124,419.

If the Raw or Insights Metadata does not match with the Risk Metadata depicting no or low access risk, the apparatus sends a signal to the application managing the File access, display, retrieval, delivery of web page, etc., and provides an indication to continue the information access process.

If the Raw or Insights Metadata does match with the Risk Metadata depicting high access risk, the apparatus sends a signal to the application managing the File access, display, retrieval, delivery of web page, etc. and provides an indication to pause access to the information in the information access process, and to display a corresponding notice message to the user attempting to access. For example, the message could state: “No Access”.

In this “No Access” scenario, a message is transmitted from the apparatus to the information owner, as indicated in the information application or otherwise, thus notifying the information owner of the Risk Metadata that matched the Raw and/or Insights transaction metadata and indicated risk level. The message may further include other information that may assist the information owner in confirming the risk indication is true or false.

If the risk indication is true, the information owner is asked by the apparatus, or via an automated process in the apparatus, whether it is desired to record the metadata combination that triggered the now validated risk notice. Additionally, the information owner may add a rule to auto-lock Files if that recorded combination is identified in the future. If the risk indication is false, the information owner is asked by the apparatus, or via an automated process in the apparatus, to unlock the File access. If provisioned, information may be sent to the attempted accessor signaling that they may continue to access the information. Alternatively, the information owner may be provided with a message indicating that they can forward the message containing information identifying File that that is now permissible to access.

The notice to the owner may be transmitted via an email, SMS, desktop tray notification, or within an application. Alternatively, it may be retrieved by API to display in other unrelated applications.

The File analyzing apparatus may perform the functions as an intermediate blocking step before permitting access to the File. Alternatively, it may operate in parallel if the analysis by the apparatus takes more than a permissible amount of time. If the process operates in parallel and subsequently detects a risk worthy of preventing access to the File, the access will be terminated upon detection, and the data representing the extent of the access (e.g., which pages of a document were accessed, for how long a file or page was viewed, whether a download was completed) is captured by the apparatus and provided to the information owner.

Additional Embodiments are described in the following:

An apparatus that transmits information to document applications and data risk and eavesdropping analyzer applications to send risk signals from the risk analyzer application to the document application to cause the document application to lock document files from end use access, the apparatus being configured to perform the functions of: receiving Raw Transaction Metadata from the document applications, transmitting the Raw Transaction Metadata received to the data risk and eavesdropping analyzer application, receiving Risk Metadata from the data risk and eavesdropping analyzer applications, transmitting to the document applications, if the Risk Metadata indicates a designated high risk level, instructions to deny end user access to the document related to the risk analysis.

Further, where access to the documents in the document application is not permitted until the Raw Transaction Metadata is analyzed by the data risk and eavesdropping analyzer applications and the apparatus returns an indicator designated low risk level, then the apparatus instructs the document application to permit end user access 108 to the document related to the document application and risk analysis.

Alternatively, where access to the documents in the document application is permitted before the Raw Transaction Metadata is analyzed or before the analysis has been completed by the data risk and eavesdropping analyzer applications and when the apparatus returns an indicator designated high risk level it sends the document application instructions to change access (interrupt and cease further access if access has already begun) to deny end user access to the document related to the document application and risk analysis.

Further, where access to the documents in the document application is permitted before the Raw Transaction Metadata is analyzed by the data risk and eavesdropping analyzer applications and when the apparatus returns an indicator designated high risk level it sends the document application instructions to change access to deny end user access to the document related to the document application; and if access has begun, interrupt and cease further access if access, and where at least one of the page identifier and time of viewing that page (“Access Information”) is recorded by the document application, receive the Access Information at the apparatus and the apparatus generates a report with the Access information, where the generated report is cryptographically rendered data authentic.

Alternatively, the system comprises of the document application and the apparatus data risk and eavesdropping analyzer applications comprising the system together that includes the document application with the document application configured to receive the risk indicators from the apparatus and performing functions based on the risk indicators, those functions including at least one of permit access to the document or deny access to the document, the document being a document related to the document application; further where at least one of the page identifier and time of viewing that page is recorded by or at the document application a report is generated by or at the apparatus where the generated report is cryptographically rendered data authentic, and where the document application includes a toggle to affirm or change the status from file lock to unlock.

In another preferred embodiment, the Auto-Lock Apparatus is in communication with the Information Asset Application Apparatus and the Risk Analyzer Apparatus, the Auto-Lock Apparatus receiving Raw Transaction Metadata associated with an Information Asset identifier from the Information Asset Application and storing the identifier with the Raw Transaction Metadata, transmitting this identifier with the Raw Transaction

Metadata to the Risk Analyzer, receiving from the Risk Analyzer the identifier with the Transaction Metadata Insights and an Overall Risk Score (e.g. red, yellow, green risk), translating the Overall Risk Score into instructions for the Information Asset Application related to the information asset associated with the asset identifier into access or action instructions (e.g. lock File, permit access to File), transmitting the access or action instructions to the Information Asset Application Apparatus, receiving information related to the Information Asset Application Apparatus having locked the information asset with information as to what pages or parts of the information asset were viewed before acting on the access instructions, the Auto-Lock Apparatus providing a report of which pages or parts of the information asset were viewed, rendering the report authenticable or tamper-detectable, and transmitting the report to the owner of the information asset identified by the identifier.

In these above preferred embodiments, the document could be a File such as a link to a web page to invoke an eSignature transaction, a file share download, a secure encrypted reply, a content viewer, and the document application could be an application managing the aforementioned File services.

### BRIEF DESCRIPTION OF THE DRAWINGS

The disclosure and various features and advantageous details thereof are explained more fully with reference to the exemplary, and therefore non-limiting, embodiments illustrated in the accompanying drawings and detailed in the following description. It should be understood, however, that the detailed description and the specific examples, while indicating the preferred embodiments, are given by way of illustration only and not by way of limitation. Detailed descriptions of known computer software, hardware, operating platforms, and protocols are omitted so as not to unnecessarily obscure the disclosure in detail. Various substitutions, modifications, additions and/or rearrangements within the spirit and/or scope of the underlying inventive concept will become apparent to those skilled in the art from this disclosure.

FIG. 1 is a schematic diagram of the Information Asset Auto-Lock System, including a process flowchart of its implementation according to an embodiment of the present disclosure.

FIG. 2 is an authentication procedure flowchart according to an embodiment of the present disclosure.

FIG. 3 is an exemplary Email Activity Report according to an embodiment of the present disclosure.

FIG. 4 is an exemplary web interface with a “locked” indicator according to an embodiment of the present disclosure.

FIG. 5 is an exemplary eSignature email interface in a locked state according to an embodiment of the present disclosure.

FIG. 6 is an exemplary eSignature application interface in a locked state according to an embodiment of the present disclosure.

FIG. 7 is an exemplary File Application Record with viewing metrics according to an embodiment of the present disclosure.

FIG. 8 is an exemplary Authenticatable Report according to an embodiment of the present disclosure.

FIG. 9 is the schematic data flowchart for an access control system incorporating Auto-Lock according to an embodiment of the present disclosure.

FIG. 10 is a schematic diagram of an information asset auto-lock system according to an embodiment of the present disclosure.

FIG. 11 is a schematic flowchart showing the relationship between the Auto-Lock Apparatus, Risk Analyzer Apparatus, and Information Asset Application Apparatus according to an embodiment of the present disclosure.

FIG. 12 is a schematic diagram of a system for generating Auto-Lock activities according to an embodiment of the present disclosure.

FIG. 13 is a schematic diagram of a computer or processing system that may be specifically modified by the various embodiments of the present disclosure.

FIG. 14 is a schematic diagram of a network used in accordance with the various embodiments of the disclosure.

FIG. 15 is a schematic flowchart showing the relationship between the Auto-Lock Apparatus, Risk Analyzer Apparatus, and Information Asset Application Apparatus, according to an embodiment of the present disclosure.

### DETAILED DESCRIPTION OF THE DRAWINGS

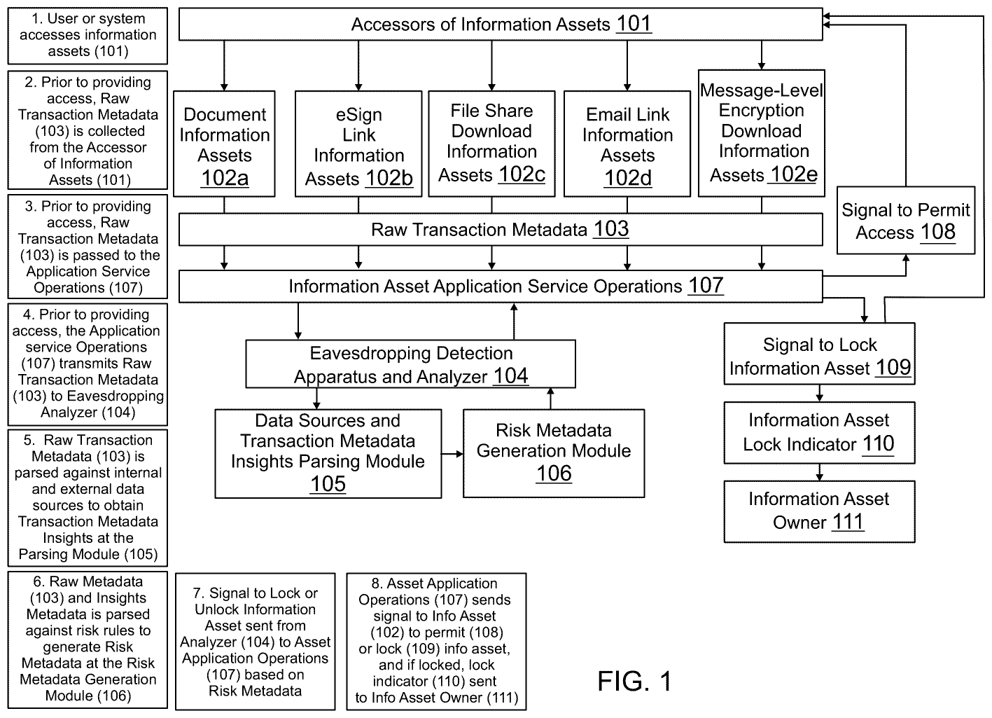

FIG. 1 shows a schematic diagram of an Information Asset Auto-Lock System, along with a schematic flowchart detailing the process steps. Accessors of Information Assets 101 may access a variety of information assets 102a-e, including document information assets 102a, eSign link information assets 102b, file share download information assets 102c, email link information assets 102d, and message-level encryption download information assets 102e. Raw transaction metadata 103, which may for instance include the IP address of the Accessor 101 or user agent information of the accessor 101, may be passed to the information asset application service operations 107. The information asset application service operations 107 is in communicative connection with an eavesdropping detection apparatus and analyzer 104. The eavesdropping detection apparatus and analyzer 104 may be connected to or may itself include a data sources and transaction metadata insights parsing module 105 and a risk metadata generation module 106.

The method Proceeds According To The Following Steps

According to step 1: A user or a system attempts to access at least one information asset 102a-e.

According to step 2: Raw Transaction Metadata 103 is collected prior to providing the Accessor 101 with access to the Information Assets 102. This Raw Transaction Metadata 103 may relate to identifying information from the Accessor 101 end relating to the information asset access attempt.

According to step 3: Prior to providing access to the information 102, Raw Transaction Metadata 103 (e.g. IP address of Accessor, User Agent information of Accessor) is passed to the Application Service Operations 107.

According to step 4: Prior to providing access to the information 102, Raw Transaction Metadata 103 received at the application service operation 107 is transmitted to Eavesdropping Analyzer 104.

According to step 5: Raw Transaction Metadata 103 is parsed against internal and external data sources to obtain Transaction Metadata Insights. This parsing may occur at a parsing module 105 which may be part of or in communicative connection with the analyzer 104.

According to step 6: Raw Metadata 103 and Insights Metadata 105 is parsed against risk rules, resulting in and Risk Metadata being generated at a risk metadata generation module 106, which may be part of or in communicative connection with the analyzer 104.

According to step 7: Based on Risk Metadata 106, a permit access signal 108 or lock asset signal 109 is sent from the Analyzer 104 to the Asset Application Operations 107.

According to step 8: Asset Application Operations 107 sends a signal to the Information Asset 102 to permit 108 or lock 109 the information asset 102. If locked 109, the Asset Application Operations 107 sends a lock indicator 110 to Information Asset Owner 111.

According to step 9: The Information Asset Owner 111 may toggle in their user interface of the Asset Application Operations 107 to change the status of the information asset 102 from Lock 109 to Permit 108, and if such occurs, the Asset Application Operations 107 sends an unlock signal 108 to the Information Asset 102 or otherwise permits the Accessor 101 to access the Information Asset 102.

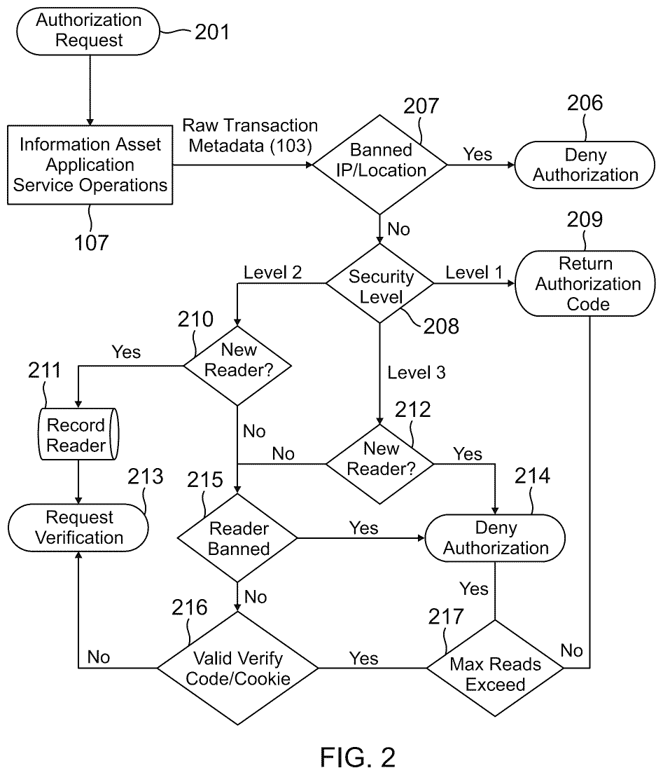

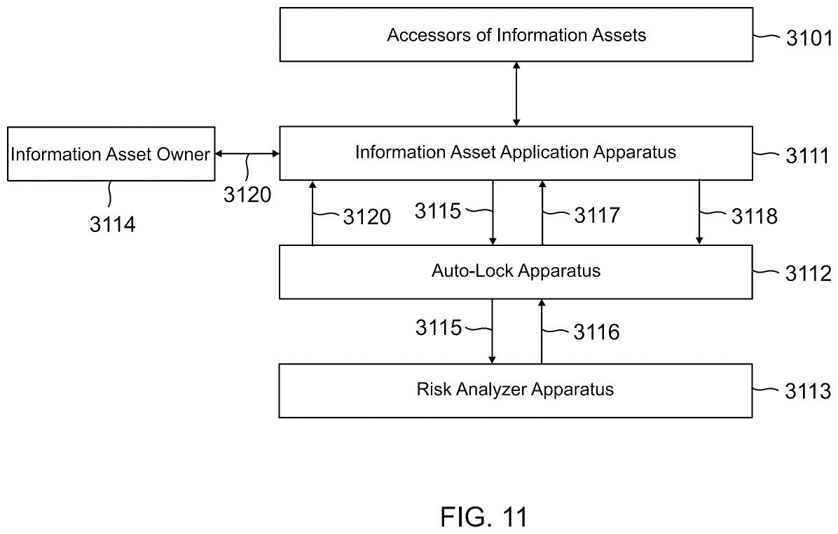

FIG. 2 shows a schematic of the information asset auto-lock system for an RPD File modified from FIG. 11 of U.S. patent application Ser. No. 18/134,480.

According to step 10: The Information Asset Application Service Operations 107 transmits the Raw Transaction Metadata 103 (e.g., IP and User Agent information) to the Eavesdropping Analyzer 104. Subsequently, an authentication protocol may be employed as described below.

In step 201, an authorization request 201 is transmitted to the Information Asset Application Service Operations 107, where an authorization procedure is engaged starting at step 207, where the system determines whether access to the document has been banned for that user, for example on the basis of the IP address, geolocation, or other pertinent control parameter.

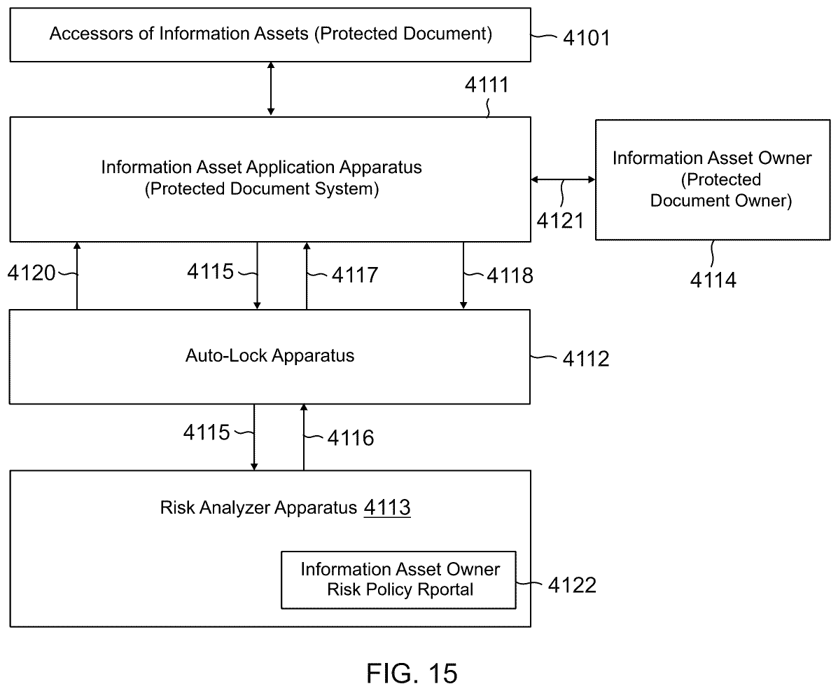

If access has been banned, the process concludes at step 206, where the system denies authorization and displays a corresponding message inside the HTML document. If access has not been banned, the process proceeds to step 208, where the system verifies the access security level. There are three tiers of Security Levels, namely Level 1 Security 1531, Level 2 Security 1532, and Level 3 Security 1533, as explained further regarding FIGS. 15-17.

If it is Level 1 Security, the process concludes at step 209, where the system returns the authentication code to the server, indicating that it is permissible to display/launch the document, thereby granting access to the reader.

If it is Level 2 Security, the process proceeds to step 210, where the system verifies whether the reader is a new reader. If the reader is a new reader, the process proceeds to step 211, wherein the Record Reader records the reader with an authentication process, and then in step 213, requests access to display/launch the document. Alternatively, if the reader is not a new reader, the process proceeds to step 215, where the system determines whether the reader is banned. If access has been banned, the process concludes at step 214, where the system denies authorization and displays a corresponding message inside the HTML document. If the reader is not banned, the process proceeds to step 216, where the system verifies the code.

If the verification code is invalid, the process concludes at step 213, where the system requests access to display/launch the document. If the verification code is valid, the process proceeds to step 217, where the system verifies whether a maximum reads limit has been exceeded, if applicable.

If a maximum reads limit has been exceeded, the process concludes at step 214, where the system denies authorization and displays a corresponding message inside the HTML document. If no maximum reads limit has been exceeded, the process concludes at step 209 where the system returns the authentication code to the server, indicating that it is permissible to display/launch the document, thereby granting access to the reader.

If it is Level 3 Security, the process proceeds to step 212, where the system verifies whether the reader is a new reader. If the reader is a new reader, the process concludes at step 214, where the system denies authorization and displays a corresponding message inside the HTML document.

Alternatively, if the reader is not a new reader, the process proceeds to step 215, where the system determines whether the reader is banned. If access has been banned, the process concludes at step 214, where the system denies authorization and displays a corresponding message inside the HTML document. If the reader is not banned, the process proceeds to step 216, where the system verifies the code and cookies.

If the verification code is invalid, the process concludes at step 213, where the system requests access to display/launch the document. If the verification code is valid, the process proceeds to step 217, where the system verifies whether a maximum reads limit has been exceeded, if applicable.

If a maximum reads limit has been exceeded, the process concludes at step 214, where the system denies authorization and displays a corresponding message inside the HTML document. If no maximum reads limit has been exceeded, the process concludes at step 209 where the system returns the authentication code to the server, indicating that it is permissible to display/launch the document, thereby granting access to the reader.

The following code segment illustrates the part of the coding for one embodiment of the present disclosure, which can be read together with FIG. 11. The code snip is a part of the server-side code that authenticates a RPD .HTML file with the server when the RPD .HTML file connects with the server at the recipient.

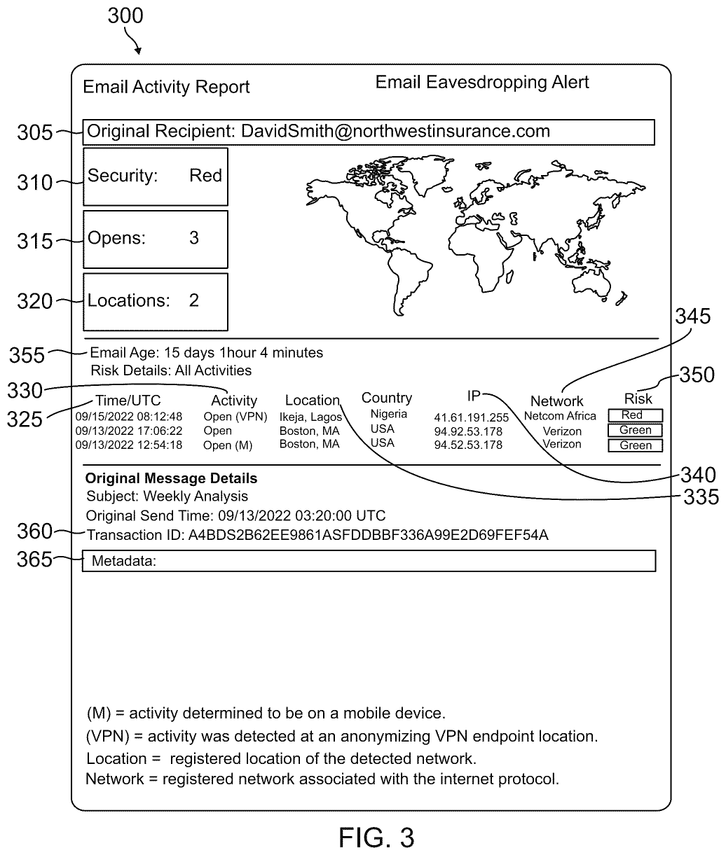

FIG. 3 shows an exemplary Email Activity Report 300 as it is for example generated by a process according to the disclosure.

The reports generated by the described methods may be returned in a variety of manners, including via email, a web portal, or in a receipt. Alternatively, it may be appended to a receipt as a digitally signed PDF report having a receipt message ID. Alternatively, it may be transmitted as a windows tray or desktop alert. Yet another alternative is for the report to be dynamically updated in a web table or in an update view associated with the sent item. Regardless of the form in which the report is transmitted, it is advantageous for the report to be presented as a table including the following fields for each recipient address:

Delivery Status 315, identifying how many unique activities were detected associated with that message to the original recipient 305. Activity classification 310, namely whether the activity related to the email based on locations or methods on how recipients acted on that email was (a) normal, or (b) high risk. Location classification 320, namely how many activities were caused at how many unique locations.

Email age information 355, the age of the email at the time the report was generated; risk and message analysis details for each activity 325 on the particular message with transaction ID 360, including the type of activity 330 that occurred on the message at each location 335 with each network IP address of the location 340 and network provider name 345 and the determined risk level of that activity 350, with metadata 365 associated with these activities or the latest activity to include portions of the message transport dialog and raw HTTP and DSN data.

Certain activity detection parameters may not be useful for purposes of detecting email eavesdropping, and therefore it may be advantageous to perform additional analysis to minimize extraneous/false alerts, for instance by automated system openings by security filters. Certain activity detection parameters may be useful additional indicators or detecting email eavesdropping and may override location related data. Exemplary relevant parameters to consider in this additional analysis include, for example:
(M)=activity determined to be on a mobile device
(CDN)=content delivery network delivered email data to viewer. This is an example of information that may override location related risk data and be a determination of lower risk.
(VPN)=activity was detected at an anonymizing VPN endpoint location. This is an example of information that may override location related risk data and be a determination of high risk.
Location=registered location of the detected network.
Network=registered network associated with the internet protocol.

These parameters may be used individually or in any combination for the computation of risk scores. Different risk scores may be factored based on this data, for example, an international location detected via a content delivery network (CDN) may be scored lower risk, and home location detected via a VPN anonymizer IP address may be scored higher risk.

To determine activity accessing the email via a VPN anonymizer, the analyzer may parse the data through additional databases, those specializing on VPN related IP addresses versus geolocation. To determine activity accessing the email via a Content Delivery Network, browser or device information, or other data, the analyzer may parse the data through additional, those specializing on lists of Networks or IP address ranges known to be Content Delivery network addresses versus geolocation, or those specializing in interpreting device and/or browser HTTP information.

Additional adjustments may need to be made to suppress reporting on repeat openings in the same location within a parameter period of time and may need to be adjusted to suppress activities recorded within a specified time from the time of original sending.

Some further parameters that may be considered in the analysis include:
(S)=activity determined to be caused by a server
(E)=activity determined to be an expert user
(M)=activity determined to be related to nefarious behavior of masking data
(B) 32 activity determined to be related to automation scripts or bots

Parameters(S), (E), (B), and (M) each draw from user agent data to identify attributes that may be associated with a higher risk level. The(S) parameter may denote when certain high-risk servers are associated with the activity, for example adding the notation when a user agent contains “apache”. The (E) parameter may denote when software associated with expert technology users is detected, for example when a user agent contains “ubuntu”, “baidu”, or “Vivaldi”. In addition to the notation, the risk level may be elevated to “yellow” unless already “yellow” or “red”. The (M) parameter may denote when activity related to nefarious behavior of masking data is detected, for instance when a user agent contains “meterpreter”, and may automatically classify the activity as a “red” risk level. The (B) parameter may denote activity associated with automation scripts, for example when a user agent contains “script”. Furthermore, when a user agent contains commands or closely associated with cybercrime, for example “nikto” or “dirb”, the risk level may be elevated to “yellow” unless already classified as “yellow” or “red”.

The email activity report 300 may include the email address of the original recipient 305, which is not the address for which every reply, forward, delivery or opening of the message or parts of the message thread may have occurred, but rather it is the original recipient for the original message send. The report 300 may prominently display a determined risk level 310 based on the most recent activity geolocation in relation to the original sender's actual home location or declared safe regions. In addition, the report may detail the total number of activities and unique locations where activities of been detected since the original email transmission. Furthermore, the report may list the Email Age 355, noting the time lapsed since the original email transmission, for example in the form of days, hours, and minutes.

A table may be included detailing information on message opens, including time 325, activity 330, location and country 335, network address 340, network 345, and risk level 350. This allows for an easy audit of the exact date and time an activity occurred, what the activity was (e.g. delivery or opening of an email), and the location (e.g. city, state, country) the activity occurred at based on the network IP address of the activity, as well as the network name. Based on this information, each activity includes a risk level categorization to put a sender on alert that their email communication may have been compromised. Additional insights into the activity can be considered when assigning a risk level, for instance if the email was open using a mobile device or personal computer or whether an anonymizing VPN was used. In embodiments where risk analysis considers more than one parameter, the report 300 may also include an additional “Reason” column (not shown), indicating to users why certain activity was classified as “green”, “yellow”, or “red”. For example, the “Reason” column may state that an activity was marked as green because of the IP address range, but not because of the location.

A transaction ID 360 may be assigned to the activity report in order to tie together multiple notices associated with the same original email sent to the original recipient. Transaction metadata 365 may also be included to provide a user or IP administrator insights to perform further analysis.

A report may be generated for each recipient email address when international activity is detected. Activity Details may provide further information about the international activity detection, for instance listing country or countries (i) other than sender home country, (ii) if more than one recipient country, and/or (iii) if at least one recipient country is not equal to sender country. An email alert may be configured based on the appropriate activity type.

According to Step 11: The Eavesdropping Detection Analyzer 104 may generate Risk Metadata 355 at the risk metadata generation module 106, which may be used for the generation of the report 300 which may be provided to the information owner 111. The Risk Indicator may be a function of Raw Transaction Metadata 340, Insights Metadata 335 and Risk Metadata 365.

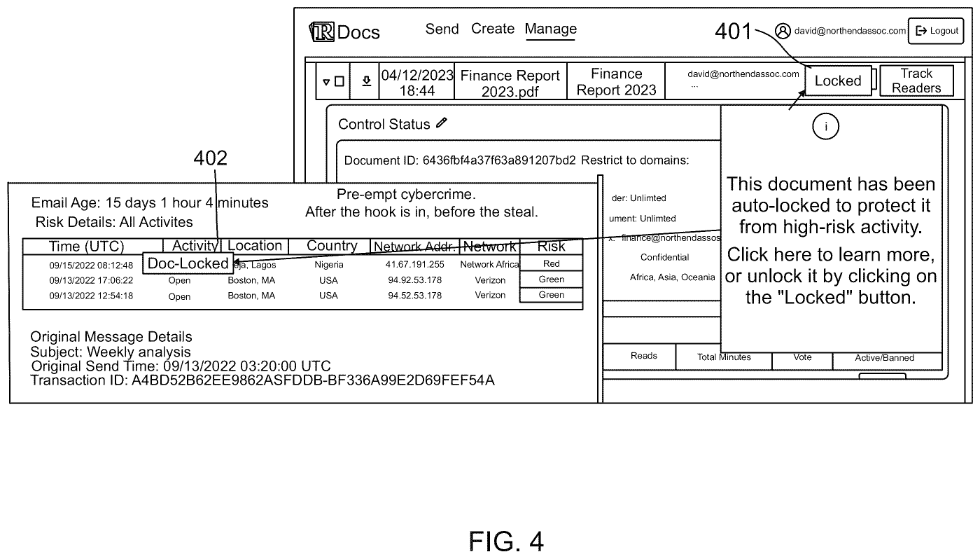

FIG. 4 shows an exemplary web interface in which risk data is reported to an information asset owner based on analysis by an eavesdropper analyzer, and the RPD file is auto-locked as a result of a high-risk determination.

According to Step 12: In the web interface of the application, for instance the RDocs application, the application displays the “Locked” indicator 401 when the access to the document is denied due to the Risk Analysis based on the identity and risk-level of an attempted accessor of the document. The “locked” indicator 401 status can be unlocked by the information asset owner by affirming the document should be accessible in the given situation. According to an embodiment, the information asset owner may override the auto-locking function by clicking on the “locked” indicator 401 in the web interface. The Risk Analyzer additionally indicates the file was locked in a report or Doc-Locked notification 402 sent to at least one of: (i) the sender, (ii) administrator of the sender, (iii) document owner, and (iv) administrator of the document owner. For instance, the Doc-Locked 402 status may appear under an activity section of a report.

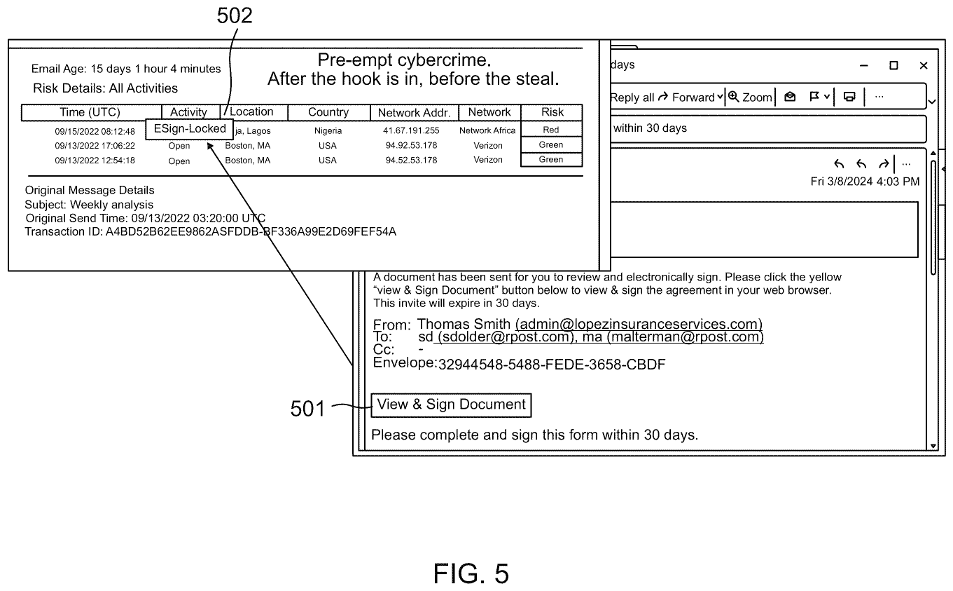

FIG. 5 shows an exemplary web or application interface in which access to an eSignature request link is locked based on a positive risk determination by the eavesdropping analyzer. This figure demonstrates an implementation of the present invention in the context of an electronic signature link transmission.

According to Step 13: If the Risk Analyzer identifies a risk activity, it sends an indicator to the eSignature application to redirect the content normally configured to display at the activation of the eSign request link 501, such that activation of the link instead displays an alternate “No Access” page. Similarly, an alert is transmitted to the eSign initiator, administrator and the eSign initiator, indicating the current activity status 502 (e.g., eSign-Locked status). The eSign initiator, administrator and the eSign initiator may optionally unlock the transmission in the eSignature application. The eSign-Locked activity status 502 may appear under an activity section of a report. In this manner, the information asset owner can prevent an unauthorized actor from viewing and electronically signing a document in a fraudulent manner.

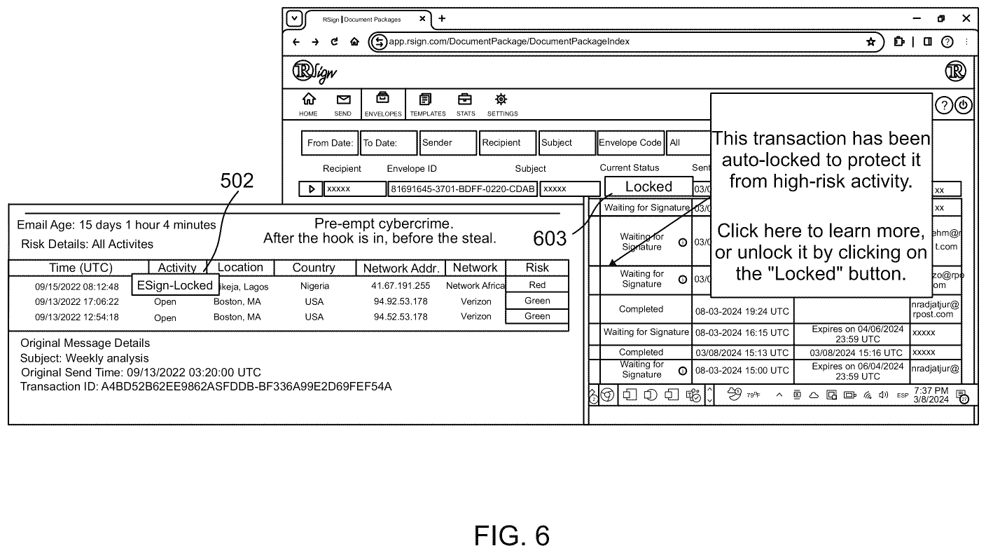

FIG. 6 shows an exemplary web or application interface in which access to a to an eSignature request link is locked based on a positive risk determination by the eavesdropping analyzer, a lock alert is transmitted to an information asset owner, and an unlock toggle is provided to override the auto-lock.

According to step 14: The information asset application service operation 107 has an interface for the information asset owner to view the current status 603 (e.g., eSignature status) of the information asset (e.g., eSign request) as being locked. This may correspond with the Activity status 502 on the notification to the information asset owner. 502 When locked, the status 603 may include a toggle where the information asset owner can unlock the transaction if they verify it as a false alert or acceptable behavior, and if such, a notification can be sent to the information asset accessor to re-try to access.

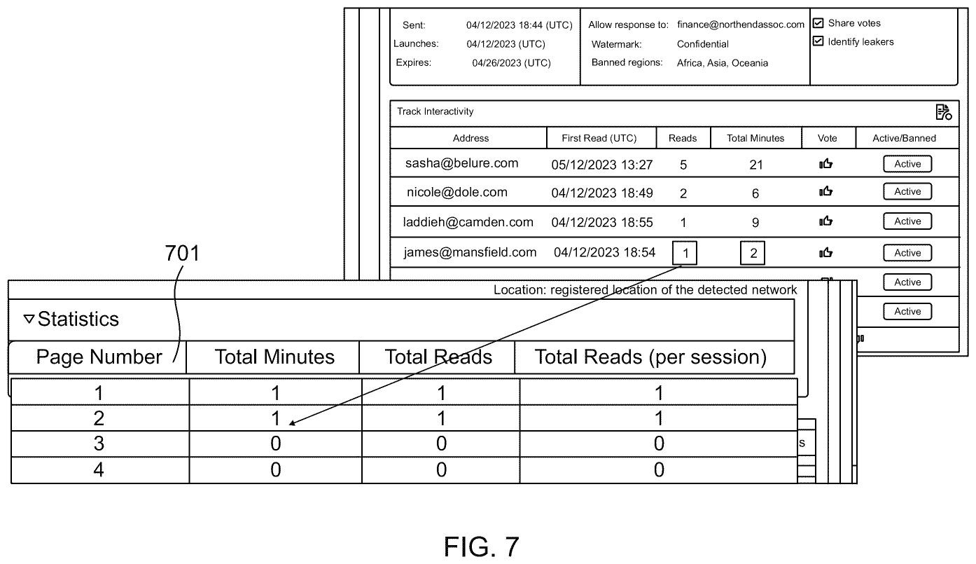

FIG. 7 shows an exemplary web or application interface including certain page view metrics related to the document.

According to step 15: If the Risk Analyzer identifies a risk activity before or after viewing was initiated, and the File is auto-locked due to an indication of high risk, the application records which pages, if any, were viewed before the file was auto-locked, as well as recording other viewing metrics, presented as a Page View Log 701.

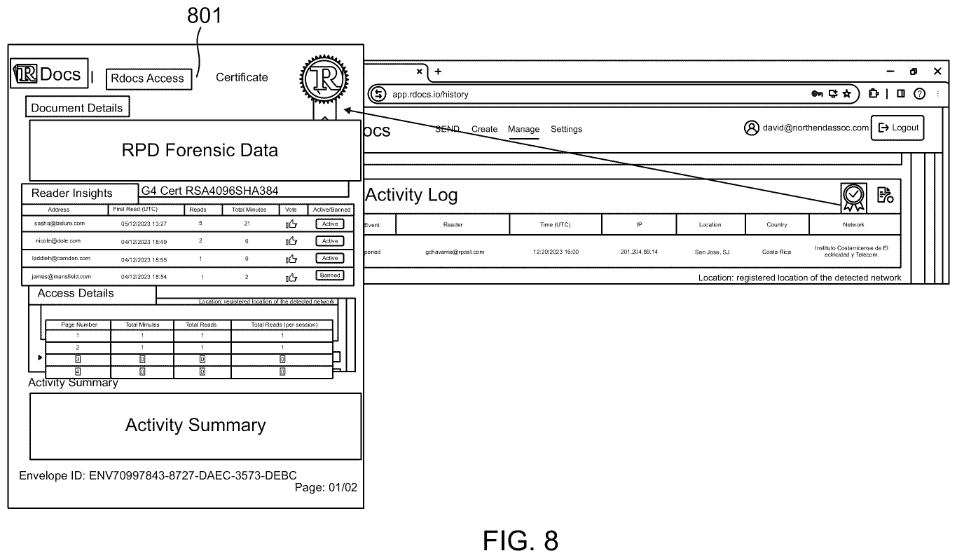

These page view metrics related to the document view prior to auto-locking may subsequently be included in a report provided to the information asset owner, as described in connection with FIG. 8. According to certain embodiments, the page view metrics can be utilized to determine whether there was a breach of sensitive information, for instance verifying that the pages viewed, displayed, printed, saved, or otherwise accessed did not include pages containing sensitive information. Further, the metrics related to time of viewing, frequency of viewing, and duration of viewing can provide further indications as to the extent of access to the information asset prior to locking.

FIG. 8 shows an activity log on a web interface with an overlaid exemplary authenticatable report of providing information on page viewing metrics and entries prior to access being locked.

According to step 16: If the Risk Analyzer identifies a risk activity before or after viewing was initiated, and the File is auto-locked due to an indication of high risk, the application records which pages, if any, were viewed prior to the file being auto-locked, as well as recording other viewing metrics, presented as a Page View Log 701 according to FIG. 7. The application generates a report of document viewing metrics, including which pages were viewed. This report may be exportable as an authenticatable content (e.g., digitally signed by the application) and timestamp sealed report 801 of the document and/or file viewing activity. This report 801 can serve as evidence of a non-breach of sensitive data. For example, if page three of the document contained the sensitive information, but page three was not viewed, no breach of the sensitive information on page three would have occurred, and this record would certify non-reportable-breach. Generative Al then evaluates the content on the viewed page and indicates whether the viewed page contains sensitive information based on certain parameters the transaction owner set as sensitive information indicators. Alternatively, if no parameters are set, the Generative Al may make a self-assessment based on some predetermined standards that the Generative Al is trained on. In this example, the content of the pages that were viewed is submitted to a Generative Al application, which reviews the contents of the viewed document pages and returns a report 801 describing which of the viewed pages contain sensitive information. The report 801 may additionally indicate whether the document was “print restricted”, and if so, indicate that the document was not printed. Alternatively, if the document was “print available”, the report 801 would indicate that the document would not be trackable after print. If ownership or control (e.g. Chattel Paper) of the designated electronic original RPD format document were transferred to a new owner, that information would additionally be recorded in the certificate.

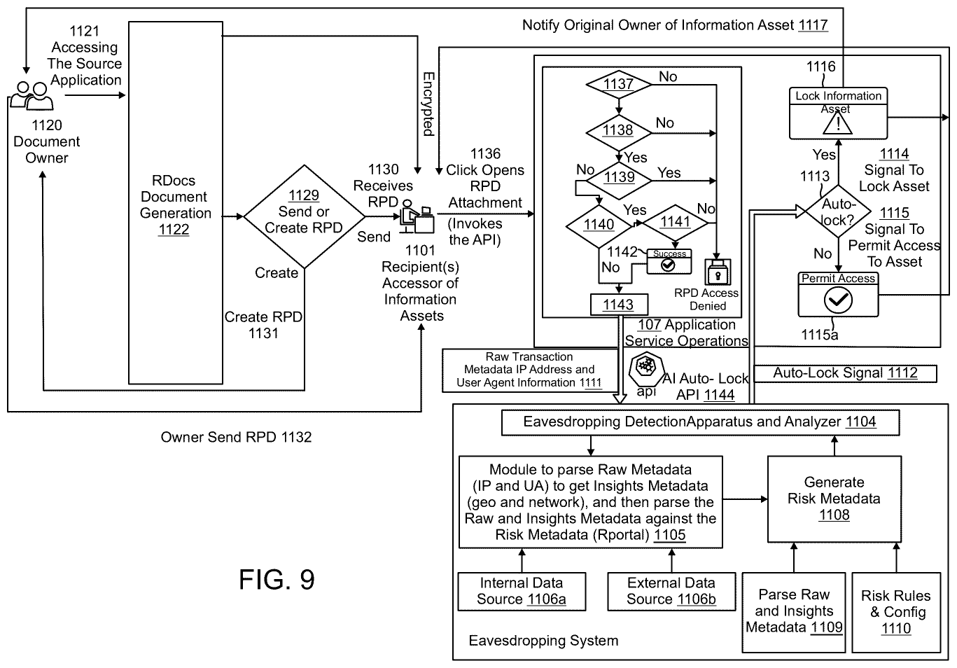

FIG. 9 shows a detailed schematic of data flow in a rights protected document with auto-lock functionality. At the onset, a document owner 1120, email sender, eSign transaction initiator, and/or file share initiator accesses the source application at step 1121, and creates or initiates the transaction at step 1122 as they would normally do for the type of information asset sharing, document related, or digital transaction at issue. At the send or create RPD module 1129, the document could be created 1131 and sent to be received by a recipient or access or the information asset at step 1130. This could be a transmission to the viewer by email, encrypted email, or other method. Alternatively, after creating, the information asset may be returned to the originator to store for later sharing, rather than immediately being transmitted to a recipient 1101. For instance, according to step 1132, the document owner 1120 may subsequently transmit this or another RPD to the recipient 1101.

According to an embodiment of the Auto-Lock of a Rights Protected Document (RPD), the viewer 1101 clicks 1136 to open the RPD document. In an alternative embodiment, the viewer 1101 could be clicking to open a link in an email that invokes a file sharing process or an eSignature transaction, or a link that displays additional redacted content in an email that displays at a web page. The application service operations 107 receives the request to access the information asset, which in this embodiment is a RPD. The request may contain some request raw metadata 1111, such as IP address of the requestor and user agent data of the requestor. The process then goes through several stages. In step 1137, it determines whether the document exists and whether its existence is associated with the Application. In step 1138, the system determines whether it a valid file that relates to the Application Service Operations 107 and whether the RPD has expired. If not expired, in step 1139 it determines whether access has been banned by the IP range, as determined by comparing banned IP range information with permissible IP range information and the IP in the Raw Transaction Metadata. If permissible to access by the viewer at this stage, then the system proceeds to step 1140 to determine whether there is a viewer multi-factor authentication step, such as entering and email to get a passcode to access the RPD. If a multi-factor authentication is required, the process proceeds to step 1141 and conducts that verification process.

Upon completion, the process proceeds to step 1142 in which the system may note that the user is authenticated via multi-factor authentication measures, but the document is yet to display. If the process fails at any step, then RPD access is denied. If the process is successful, the process proceeds to step 1143, namely verification of the AI Auto-Lock.

At this point in the process, the Raw Transaction Metadata 1111 is parsed into the AI Auto-Lock process 1143 which passes the Raw Transaction Metadata 1111 into the Risk Analyzer 1104 via API 1144 or other means. Alternatively, this step could occur at earlier stages in the process prior to document display, for instance associated with the IP authentication of step 1139 or multi-factor authentication of step 1141. At the parsing module 1105, the Risk Analyzer 1104 executes the steps of parsing the Raw Transaction Metadata 1111 (e.g., IP and User Agent information) against internal data sources 1106a and external data bases 1106b to generate Transaction Metadata Insights from the Raw Transaction Metadata 1111. The Raw Transaction Metadata 1111 may include the Network Name, Type of Network (content delivery network, virtual private network, anonymizing network, proxy, etc.), Geolocation, Type of Device (e.g., mobile, server, browser), Device Default Language, and more.

The Transaction Insight Metadata is then combined with the Raw Transaction Metadata 1111 to form the Risk Metadata 1108, which may be stored in the risk analyzer apparatus 2125. At step 1109, raw transaction data 1111 and Transaction Insights Metadata may be parsed. These are analyzed against risk rules and configurations 1110 established by the information asset owner 1120, their administrators, or based on past use patterns. If any part of the Raw Transaction Metadata 1111 or Transaction Insights Metadata match any part of the Risk Metadata 1108, then a signal of “Lock Transaction” is transmitted to the analyzer 1104 and into the Application Service Operations 107 for that information asset 102, in this case, for the RPD file.

A module at the Application Service Operations 107 is configured to receive the Auto- Lock signal 1112 from the analyzer 1104 and invoke the file auto-lock process 1113. The auto-lock process 1113 may signal the asset to lock 1114 the information asset 102 and display a “No Access” indication 1116 to the viewer 1101. Alternatively, if access is permitted and access signal 1115 is transmitted, the file is displayed 1115a to the viewer. If the system is locked 1116, the system sends a notice 1117 and report to the original asset owner 1120 or their administrators with information about the file locking. The application may provide a means for the original owner 1120 to override the lock 1116 if the owner 1120 determines the risk analysis to be false, in which case, the information asset 102 would become re-available to the viewer 1101, along with a notice that the information asset 102 is now available and is ready to re-attempt to access.

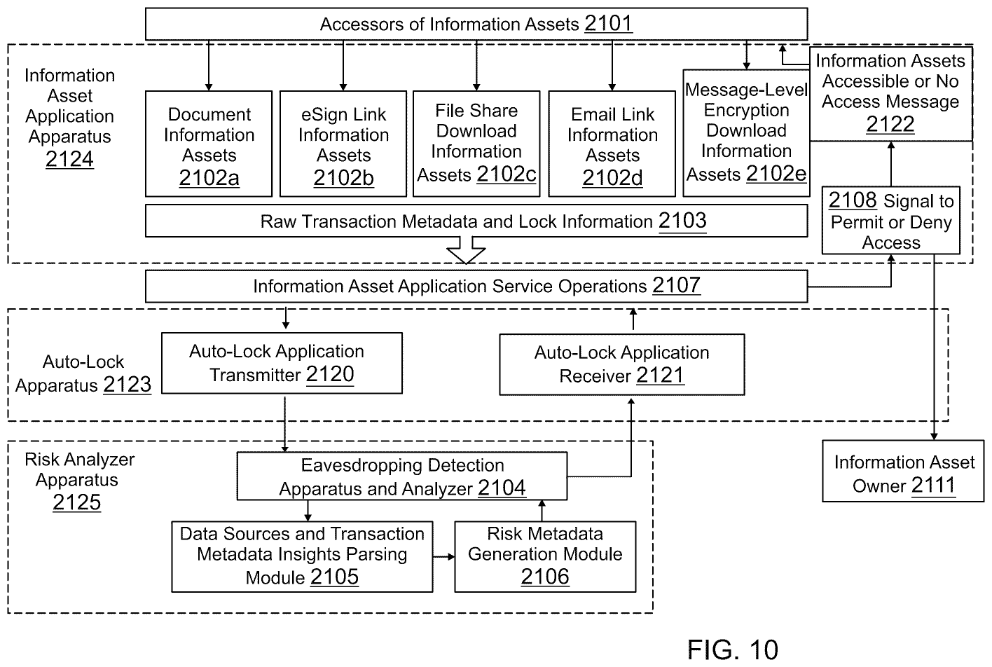

FIG. 10 shows three apparatus components, namely: (i) the Information Asset Application, 2124 which is the application that manages the information asset access (e.g. file share system, rights protected document system, eSignature system), (ii) the Auto-Lock Apparatus 2123, and (iii) the Risk Analyzer Apparatus 2125.

In an embodiment of the invention, the main component is the Auto-Lock Apparatus 2123, which interfaces with the Asset Application 2124, which may be separate from the Auto-Lock Apparatus 2123 but programmed to facilitate transmission of the Raw Transaction Metadata 2103 to the Auto-Lock Apparatus 2125. Alternatively, the Asset Application 2124 may perform this function through communication with a component of the Auto-Lock Apparatus 2123 connected to or located at the Asset Application 2124. Based on a risk assessment as described below, the Asset Application 2124 may be configured to receive a Lock or Not Lock signal 2108 from the Auto-Lock Apparatus 2123, which the Information Asset Application 2124 would use to invoke the action on the document, link or Files.

In this embodiment of the invention, the main component, the Auto-Lock Apparatus 2123, connects with the Risk Analyzer 2125. The Risk Analyzer 2125 may be separate from the Auto-Lock Apparatus 2123 but programmed to receive transmission of the Raw Transaction Metadata 2103 sent from the Auto-Lock Apparatus 2123, and send a risk level indicator (e.g., High Risk) to the Auto-Lock Apparatus 2123, such that the Auto-Lock Apparatus 2123 may invoke the action on the document, link or Files in communication with the Information Asset Application 2124. Alternatively, the Asset Application 2124 may perform this function through communication with a component of the Auto-Lock Apparatus 2123 connected to or located at the Risk Analyzer 2125. These connections could be performed with Application Programming Interfaces.

In an alternative embodiment, the three apparatus components shown, the Information Asset Application 2124, the Auto-Lock Apparatus 2123, and the Risk Analyzer apparatus 2125 are all part of the same system.

In another alternative embodiment, two of the three apparatus components shown, the Information Asset Application 2124 and the Auto-Lock Apparatus 2123 are part of the same system, which is separate from the Risk Analyzer apparatus 2125.

In another alternative embodiment, two of the three apparatus components shown, the Auto-Lock Apparatus 2123 and the Risk Analyzer apparatus 2125 are part of the same system, while the Information Asset Application 2124 is separate but connected as described.

The attempted viewer 2101 of the information assets 2102a-e (e.g., rights protected document which can be a document that resides as an attachment to an email at the attempted viewer) attempts to access the information asset 2102a-e, which transmits Raw Transaction Metadata 2103 to the Information Asset Application Service Operations 2107 that is connected to the Auto-Lock Apparatus 2123.

The Auto-Lock Apparatus 2123 includes an auto-lock application transmitter 2120 configured to transmit the received Raw Transaction Metadata 2103 to the Risk Analyzer 2125. The auto-lock application receiver 2121 receives a Risk Determination from the risk analyzer 2125. The Risk Determination may indicate the document is locked or access is permitted. Upon receiving the Risk Determination, it signals a component of the Information Asset Application Service Operations 2107 to permit or deny access to the connected information asset 2102a-e. The Information Asset Application Service Operations 2107 is configured to receive and act on the risk determination and may provide for the signal 2108 to be acted on. The information assets 2102a-e may include Document Information Assets 2102a, eSign Link information Assets 2102b, File Share Download Information Assets 2102c, Email Link Information Assets 2102d, and Message-Level Encryption Download Information Assets 2102e. Accordingly, based on the signal 2108, the information asset 2102a-e is either made available or is locked to the accessor and accompanied by a “no access” message 2122. If not made available, the signal prompts the Auto-Lock application 2123 to issue a notification to the information owner 2111 and provide an optional override process for the original information owner 2111 or their administrator to unlock the file.

The risk determination is made by the Risk Analyzer Apparatus 2125, which may include the eavesdropping detection apparatus and analyzer 2104, data sources and transaction metadata insights parsing module 2105, and Risk Profile data generated by the risk metadata generation module 2106. The received Raw Transaction Metadata 2103 is parsed against internal and external data sources in the parsing module 2105 to receive Transaction Metadata Insights. Raw Metadata 2103 (e.g. IP address, User Agent information) and Insights Metadata (e.g. Network, Geolocation associated with the Raw Metadata IP address, VPN list, Proxy Server list, Device Language) is parsed against risk rules (e.g. asset owner permissible IP range, geo-location, default language of viewer). Risk Metadata is generated at the risk metadata generation module 2106, which is parsed from eavesdropping detection apparatus and analyzer 2104 to auto-lock application receiver 2121. The Auto-Lock Application Server sends the signal 2108 to the Information Asset Application Service Operations 2107 to either “Lock” or “Permit” File access.

FIG. 11 shows a schematic diagram of an auto-lock apparatus 3112 and its communication links with system components. In another preferred embodiment, an Auto-Lock Apparatus 3112 is in communication with an Information Asset Application Apparatus 3111 and a Risk Analyzer Apparatus 3113. The Auto-Lock Apparatus 3112 may be configured to receive Raw Transaction Metadata 3115 associated with an Information Asset identifier from the Information Asset Application 3111, and store the identifier with the Raw Transaction Metadata 3115. This identifier with the Raw Transaction Metadata 3115 is transmitted to the Risk Analyzer 3113, which returns the identifier with the Transaction Metadata Insights and an Overall Risk Score 3116 (e.g. red, yellow, green risk). The Overall Risk Score 3116 is translated into access or action instructions 3117 (e.g. lock File, permit access to File) for the Information Asset Application 3111 related to the information asset associated with the asset identifier. The access or action instructions 3117 are transmitted to the Information Asset Application Apparatus 3111. Subsequently, the Auto-Lock Apparatus 3112 receives page view information 3118 from the Information Asset Application Apparatus 3111 as to what pages or parts of the information asset were viewed before locking the information asset based on the access instructions 3117. The Auto-Lock Apparatus 3112 may be configured to provide a report 3120 of which pages or parts of the information asset were viewed, render the report 3120 authenticable or tamper-detectable, and transmit the report 3120 to the information asset owner 3114 identified by the identifier via the Information Asset Application Apparatus 3111.

The Auto-Lock Apparatus 3112 may be configured to operate on a server remote from the information asset owner 3114 and the information asset accessor 3101. The Auto-Lock Apparatus 3112 may be remote from the Information Asset Application Apparatus 3111, or alternatively be combined therewith. Likewise, the Auto-Lock Apparatus 3112 may be remote from the Risk Analyzer Apparatus 3113, or alternatively be combined therewith. The communication between the Auto-Lock Apparatus 3112, Information Asset Application Apparatus 3111, and the Risk Analyzer Apparatus 3113 is facilitated via Application Programming Interfaces and secure data exchanges.

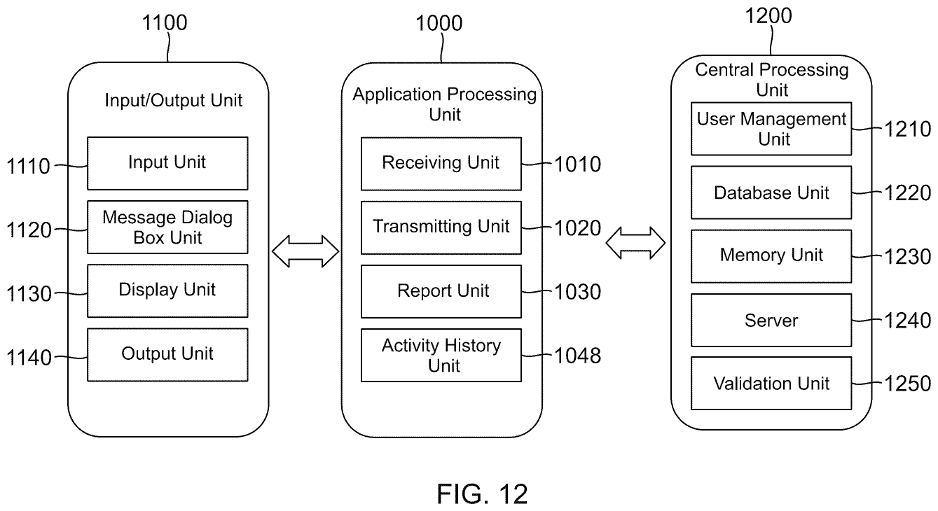

FIG. 12 is a schematic diagram of the components of the Auto-Lock Apparatus 3112. The-Lock Apparatus 3112 comprises an Application Processing Unit 1000, an Input/Output Unit 1100, and a Central Processing Unit 1200. The Application Processing

Unit 1000 comprises a Receiving Unit 1010, a Transmitting Unit 1020, a Report Unit 1030 and an Activity History Management Unit 1048. The Report Unit 1030 may encompass also instruction creation and sending functionalities. The Input/Output Unit 1100 comprises an Input Unit 1110, a Message Dialog Box Unit 1120, a Display Unit 1130, and an Output Unit 1140. The Central Processing Unit 1200 comprises a User Management Unit 1210, a Database Unit 1220, a Memory Unit 1230, a Server 1240, and a Validation Unit 1250. Receiving Unit 1010 may be configured to receive, for example, the original Raw Metadata, Metadata Insights, and Risk Metadata. The Report Unit 1030 may be configured to create reports using a creation process, and transmit the reports by email or other means.

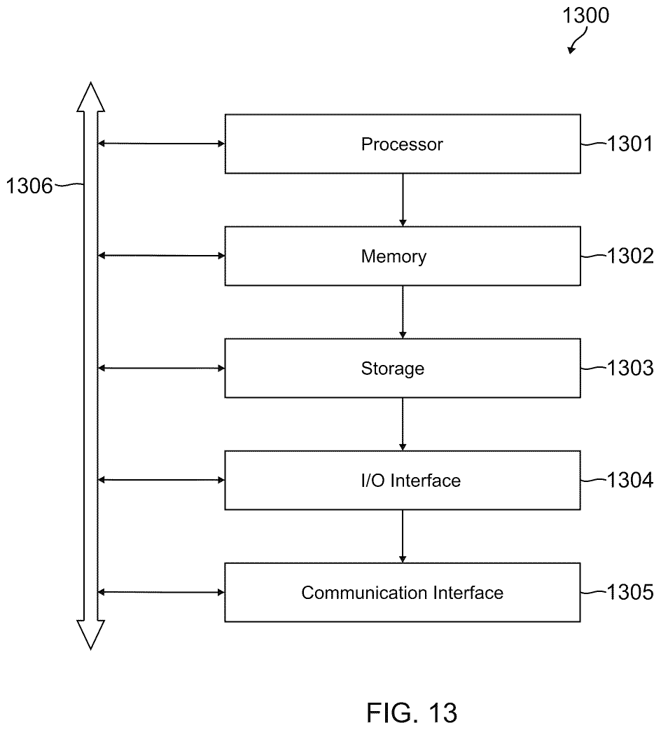

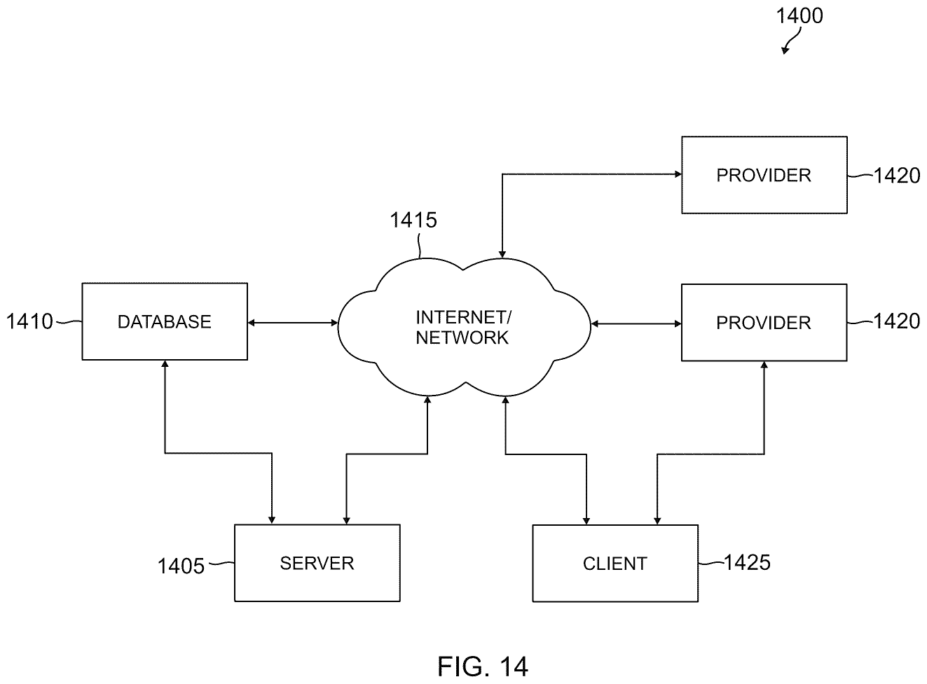

The Central Processing Unit 1200 relates to the elements of the computer system 1300 of FIG. 13 and the network of FIG. 14. The User Management Unit 1210 may be configured to manage and control user accounts and activities relating to user access. The Database Unit 1220 may include one or more databases. Memory Unit 1230 and Server 1240 may perform the functions of corresponding elements 1302 and 1405, as described regarding FIGS. 13 and 14. Validation Unit 1250 may be configured to perform functions relating to the validation of users.

The Input/Output Unit 1100 performs a variety of functions described in the processes shown for instance in FIGS. 1, 9, 10, 11, and 15. The Input Unit 1110 may be configured to receive inputs into the system, for instance data transmitted to the system or entered via an interface. Message Dialog Box Unit 1120 may output dialog messages. Display Unit 1130 may enable display of various interfaces. Output Unit 1140 may be configured to provide outputs from the system.

FIG. 13 illustrates an exemplary computer system 1300 which may be used with some embodiments of the present invention, which may be, for example, a server or a client computer system. Computer system 1300 may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, etc. Computer system 1300 may be a combination of multiple forms. Computer system 1300 may include one or more computer systems 1300, be unitary or distributed, span multiple locations, span multiple systems, or reside in a cloud (which may include one or more cloud components in one or more networks).

In one embodiment, computer system 1300 may include one or more processors 1301, memory 1302, storage 1303, an input/output (I/O) interface 1304, a communication interface 1305, and a bus 1306. Although this disclosure describes and illustrates a particular computer system having a particular number of particular components in a particular arrangement, this disclosure contemplates other forms of computer systems having any suitable number of components in any suitable arrangement.

In one embodiment, processor 1301 includes hardware for executing instructions, such as those making up software. Herein, reference to software may encompass one or more applications, byte code, one or more computer programs, one or more executable module or API, one or more instructions, logic, machine code, one or more scripts, or source code, and or the like, where appropriate. As an example, and not by way of limitation, to execute instructions, processor 1301 may retrieve the instructions from an internal register, an internal cache, memory 1302 or storage 1303; decode and execute them; and then write one or more results to an internal register, an internal cache, memory 1302, or storage 1303. In one embodiment, processor 1301 may include one or more internal caches for data, instructions, or addresses. Memory 1303 may be random access memory (RAM), static RAM, dynamic RAM or any other suitable memory. Storage 1305 may be a hard drive, a floppy disk drive, flash memory, an optical disk, magnetic tape, or any other form of storage device that can store data (including instructions for execution by a processor).

In one embodiment, storage 1303 may be mass storage for data or instructions which may include, but not limited to, a HDD, solid state drive, disk drive, flash memory, optical disc (such as a DVD, CD, Blu-ray, and the like), magneto optical disc, magnetic tape, or any other hardware device which stores computer readable media, data and/or combinations thereof. Storage 1303 maybe be internal or external to computer system 1300.

In one embodiment, input/output (I/O) interface 1304 includes hardware, software, or both for providing one or more interfaces for communication between computer system 1300 and one or more I/O devices. Computer system 1300 may have one or more of these I/O devices, where appropriate. As an example, but not by way of limitation, an I/O device may include one or more mouses, keyboards, keypads, cameras, microphones, monitors, displays, printers, scanners, speakers, cameras, touch screens, trackball, trackpad, biometric input device or sensor, or the like.

In still another embodiment, a communication interface 1305 includes hardware, software, or both providing one or more interfaces for communication between one or more computer systems or one or more networks. Communication interface 1305 may include a network interface controller (NIC) or a network adapter for communicating with an Ethernet or other wired-based network or a wireless NIC or wireless adapter for communications with a wireless network, such as a Wi-Fi network. In one embodiment, bus 1306 includes any hardware, software, or both, coupling components of a computer system 1300 to each other.

FIG. 14 is a graphical representation of an exemplary network 1400 that may be used to facilitate the various embodiments of the present invention. Server 1405 is operated by a services organization 1420, and typically includes at least one processor, input and output equipment or devices, memory, storage, and a communication interface. The server 1405 also operates under the control of specialized software programming commands that are designed to carry out the various processes described above. It should be understood that while the exemplary network 1400 is described in terms of a server 1405 operated by a services organization 1420, the server 1405 could be operated by a third party hired by the services organization or under the control of the services organization. The server 1405 could also be operated by a third party independent of the services organization, which then provides information and/or data to the services organization from which the services organization may provide services to a client 1425 of the services organization.

A data storage device 1410, which may be separate from the server 1405, but not necessarily, may be accessible to the server 1405, and may be used for storing date related to information and any other data related to operation of the various embodiments of the system and method described above. The data storage device 1410 may directly connected to the server 1405, or it may be accessible to the server 1405 through a network or the Internet 1415. The data storage device 1410 may also be a virtual storage device or memory located in the Cloud.

These diagrams are describing some embodiments of the various embodiments of this disclosure, those skilled in the art will understand that there are other embodiments and more details within each of these embodiments not depicted in these diagrams.

Although the disclosed system has been described hereabove with reference to certain examples or embodiments, various additions, deletions, alterations and modifications may be made to those described examples and embodiments without departing from the intended spirit and scope of the disclosed heat exchange system. For example, any elements, steps, members, components, compositions, reactants, parts or portions of one embodiment or example may be incorporated into or used with another embodiment or example, unless otherwise specified or unless doing so would render that embodiment or example unsuitable for its intended use. Also, where the steps of a method or process have been described or listed in a particular order, the order of such steps may be changed unless otherwise specified or unless doing so would render the method or process unsuitable for its intended purpose. Additionally, the elements, steps, members, components, compositions, reactants, parts or portions of any embodiment or example described herein may optionally exist or be utilized in the absence or substantial absence of any other element, step, member, component, composition, reactant, part or portion unless otherwise noted. All reasonable additions, deletions, modifications and alterations are to be considered equivalents of the described examples and embodiments and are to be included within the scope of the following claims. The disclosure is limited only by the scope of the appended claims.

FIG. 15 shows a schematic diagram of the information asset auto-lock system with protected document ownership transfer functionality. In this embodiment, the information asset 102 is a Rights Protected Document (RPD). Accessors of the protected document 4101 access the document through a protected document application, namely an information asset application apparatus 4111.

The Auto-Lock Apparatus 4112 is in communication with the Information Asset Application Apparatus 4111 and the Risk Analyzer Apparatus 4113. The Risk Analyzer Apparatus 4113 includes a risk policy module 4122 customized to the Information Asset Owner 4114. The risk policy module 4122 may specify indicators that would be considered high-risk in the view of the information asset owner 4114 or their administrators. These specified indicators may be used in the risk determination for triggering the information asset auto-lock.

The Auto-Lock Apparatus 4112 may be configured to receive Raw Transaction Metadata 4115 associated with an Information Asset identifier from the Information Asset Application 4111. The Auto-Lock Apparatus 4112 may further be configured to store the identifier with the Raw Transaction Metadata 4115. This identifier with the Raw Transaction Metadata 4115 may be transmitted from the Auto-Lock Apparatus 4112 to the Risk Analyzer Apparatus 4113.

The Auto-Lock Apparatus 4112 may subsequently receive from the Risk Analyzer Apparatus 4113 the identifier with the Transaction Metadata Insights and an Overall Risk Score 4116 (e.g. red, yellow, green risk). The Overall Risk Score 4116 may be translated into access or action instructions 4117 (e.g. lock File, permit access to File) for the Information Asset Application 4111 related to the information asset associated with the asset identifier. The access or action instructions 4117 may be transmitted to the Information Asset Application Apparatus 4111. The Auto-Lock Apparatus 4112 receives page view information 4118 from the Information Asset Application Apparatus 4111 as to what pages or parts of the information asset were viewed before locking the document based on the access instructions 4117. The Auto-Lock Apparatus 4112 may provide a report 4120 of which pages or parts of the information asset were viewed, render the report authenticable or tamper-detectable, and transmit the report 4120 to the owner of the information asset 4114, as identified by the identifier via the Information Asset Application Apparatus 4111.

The Auto-Lock Apparatus 4112 may operate on a server remote from the information asset owner 4114 and information asset accessor 4101. The Auto-Lock Apparatus 4112 may be remote from the Information Asset Application Apparatus 4111 or alternatively be combined therewith. Likewise, the Information Asset Application Apparatus 4111 may be remote from the Risk Analyzer Apparatus 4113, or alternatively be combined therewith. The communications between the Auto-Lock Apparatus 4112, Information Asset Application Apparatus 4111, and the Risk Analyzer Apparatus 4113 may be facilitated via Application Programming Interfaces and secure data exchanges.

The Information Asset Owner 4114, or their administrator, has the ability to transfer ownership of the information asset (e.g., protected document) to a new owner. Upon transfer, the history of the document metadata, access history, and controls in the information asset application apparatus 4111 (i.e., protected document system) is transferred within the same application to the account of the new information asset owner. With the transfer of document ownership, the information asset owner risk policy that applies to the Risk Analyzer apparatus 4113 is the risk policy of that new information asset (RPD) owner. Due to the design of the rights protected document, the documents themselves do not need to be moved or transferred. The ownership is transferred by the document owner, which transfers the rights and history and policies that apply to the document wherever the document itself is.

After transfer, marketings on the document, including all copies in circulation, are automatically updated to have the new owner risk policies. For example, if a current owner does not want the protected document to be viewed outside of the United States and the new owner does not want the document to be viewed outside of the United Kingdom, after the transfer to the new owner, all versions of the document in circulation are updated to only be accessible in the United Kingdom.

In each of these embodiments, it is contemplated that the risk analyzing may take time and the access to the information asset may need to proceed while the risk analysis continues in parallel. When the risk analysis has been completed and the risk analyzer 4113 determines the information asset should be locked, the auto-lock signal may be transmitted and interrupt the viewing of the information asset.

For example, the invention could have a configurable detection timeout to lock the document. To account for the inherent variable speeds of the Internet, servers and user hardware, the locking of the document could be configurable by time. In this example, if the time-out setting is set to 2 seconds, and if the Auto-Lock Apparatus 4112 risk analysis completes within 2 seconds, the application either shows or auto-locks the document depending on the result of the risk determination. If the Auto-Lock Apparatus 4112 risk analysis takes more than 2 seconds, the application displays the content but record data on which pages were viewed and the time at which each page was viewed. If after 2 seconds the system determines that a document is viewed in a location outside of the sender's ‘safe’ zone, then the Auto-Lock Apparatus 4112 signals to the Information Asset Application Service Operations 107 to immediately lock the Files even if partially viewed. Subsequently, a report is sent to the sender noting the pages viewed and the time spent on each page.

Further, in each of these embodiments, it is contemplated each apparatus or application will store a copy of the data that it receives, transforms, and transmits, at least temporarily, in a database.

Further, in each of these embodiments, it is contemplated that the metadata transmitted, received, or generated is associated with an information asset document identifier and the information transmitted or stored includes association with the information asset.

Further, in each of these embodiments, it is contemplated that the Auto-Lock Apparatus 4112 operates on a server remote from the information asset owner 4114 and information asset accessor 4101. The Auto-Lock Apparatus 4112 may be remote from the Information Asset Application Apparatus 4111, or alternatively be combined therewith. Likewise, the Auto-Lock Apparatus 4112 may be remote from the Risk Analyzer Apparatus 4113, or alternatively be combined therewith. The communications between the Auto-Lock Apparatus 4112, Information Asset Application Apparatus 4111 and the Risk Analyzer Apparatus 4113 is facilitated via Application Programming Interfaces and secure data exchanges.

According to an embodiment, the information asset application 3111 may be configured to lock the information asset based on the access instructions received from the auto-lock apparatus 3112 and provide a capability to override the initial lock of the information asset based on receipt of an indication. For example, a user may click to override the lock as they want to remotely permit it. The indication may be receipt of instructions from an attempted accessor of the information asset that is approved by the system or owner of the information asset or receipt of an indication into the system.

According to an embodiment, the information asset application 3111 may be configured to lock the information asset based on the access instructions received from the auto-lock apparatus 3112 and provide a capability to override the initial lock of the information asset based on receipt of an indication, and if the override unlocks the information asset, the access instructions received from the auto-lock apparatus 3112 that caused the lock of the information asset is stored in memory at the system, and if identical access instructions received from the auto-lock apparatus 3112 are received for the information asset or a related information asset, the auto-lock apparatus does not lock the information asset. For example, the info asset owner may click to override the lock as they want to remotely permit it. After receipt of indication that it should remain accessible, and they override to remotely make the information asset now accessible, the system remembers what triggered the information asset to lock and creates an indication that if that same trigger re-occurs, not to lock the asset or related asset. The related asset could be an information asset from that same sender to the same receiver within a set time parameter. This functionality overcomes a disadvantageous scenario in which a viewer opens a document that was locked but then overridden (e.g., false positive) and the document subsequently keeps auto-locking each time the same person tries to open, thereby causing a problem from a user perspective.

According to an embodiment, an apparatus for auto-locking a document may be provided, wherein an information asset application 3111 is configured to lock the information asset based on access instructions received from an auto-lock apparatus 3112 and provide a capability to override the initial lock of the information asset based on receipt of an indication, and if the override locks the information asset, the access instructions received from the auto-lock apparatus 3112 that caused the lock of the information asset is stored in memory at the system. If identical access instructions received from the auto-lock apparatus 3112 are received for the information asset or a related information asset, the auto-lock apparatus does not lock the information asset. For example, if an info asset owner clicks to override the lock as they want to remotely permit it, after receipt of indication that it should remain accessible, and they override to remotely make the information asset now accessible, and the system remembers what triggered the information asset to lock and creates an indication that if that same trigger re-occurs, not to lock the asset or related asset, related asset would be an information asset from that same sender to the same receiver within a set time parameter.

The skilled artisan would appreciate that the present disclosure discusses an apparatus, system, and method operable for file access restrictions beyond common denial of log-in access in a website or application login, where access to log into the application may be restricted based on certain indicators (e.g., geolocation of the login requests origin).

1. A system for auto-locking a document, said system comprising:
an auto-lock apparatus communicatively connected to an information asset application and a risk analyzer application; wherein
the auto-lock apparatus is configured to:
(i) receive raw transaction metadata associated with an information asset identifier from the information asset application;
(ii) store the identifier with raw transaction metadata; and
(iii) transmit the identifier with the raw transaction metadata to the risk analyzer application;
the risk analyzer application is configured to:
(i) receive an identifier with the raw transaction metadata from the auto-lock apparatus;
(ii) generate an overall risk score based on the raw transaction metadata; and
(iii) transmit the information asset identifier with an overall risk score to the auto-lock apparatus; and
the auto-lock apparatus is further configured to transform the overall risk score into access instructions related to the information asset for transmittal to the information asset application.

2. The system for auto-locking a document according to claim 1, wherein the information asset application is configured to lock or unlock the information asset based on the access instructions received from the auto-lock apparatus.

3. The system for auto-locking a document according to claim 2, wherein the information asset application is configured to transmit page view information to the auto-lock apparatus, and wherein the page view information indicates which parts of the information asset were viewed before locking the information asset.

4. The system for auto-locking a document according to claim 3, wherein the auto-lock apparatus is further configured to:
generate an authenticable report indicating which parts of the information asset were viewed; and
transmit the authenticable report to the owner of the information asset.

5. The system for auto-locking a document according to claim 4, wherein the authenticable report further indicates the time at which each part of the information asset was viewed.

6. The system for auto-locking a document according to claim 1, wherein the raw transaction metadata includes at least one of: network address, network name, network type, geolocation, device type, and device default language.

7. The system for auto-locking a document according to claim 2, wherein the information asset application is further configured to:
transmit a notification to the information owner after auto locking the document; and
receive lock override instructions or lock confirmation instructions from the information asset owner.

8. The system for auto-locking a document according to claim 7, wherein if lock override instructions unlock the information asset, the original locking access instructions are stored in memory at the system, and the information asset application is configured to ignore subsequent locking access instructions received from the auto-lock apparatus for the information asset.

9. The system for auto-locking a document according to claim 1, wherein the information asset is a document that is not accessed via a log-in user access process.

10. A method for auto-locking a document, including the steps of:
(i) transmitting raw transaction metadata associated with an information asset identifier from an information asset application to an auto-lock apparatus;
(ii) storing the information asset identifier with the raw transaction metadata in the auto-lock apparatus;
(iii) transmitting the information asset identifier with the raw transaction metadata from the auto-lock apparatus to a risk analyzer;
(iv) generating an overall risk score based on the raw transaction metadata;
(v) transmitting the information asset identifier with an overall risk score from the risk analyzer to the auto-lock apparatus;
(vi) translating the overall risk score into actionable access instruction, namely to lock or unlock the information asset;
(vii) transmitting the access instructions from the auto-lock apparatus to the information asset application.

11. The method according to claim 10, wherein after originally permitting access to the document, it is subsequently auto-locked upon rendering of a high-risk determination.

12. The method according to claim 11, further comprising the step of:
(viii) transmitting page view information from the information asset application apparatus to the auto-lock apparatus indicating parts of the information asset were viewed before locking the information asset.

13. The method according to claim 12, further comprising the steps of:
(ix) generating an authenticable report at the auto-lock apparatus indicating which parts of the information asset were viewed and the time at which viewing occurred; and
(x) transmitting the authenticable report to the owner of the information asset.

14. The method according to claim 13, further comprising the step of cryptographically rendering the generated report data authentic.

15. The method according to claim 10, further comprising the step of transmitting a notification to the information owner after auto locking the document, permitting an optional override function to unlock the file.

16. The method according to claim 10, wherein the overall risk score determination of step (iv) further includes parsing the raw transaction metadata against internal and external data sources to obtain transaction insights metadata.

17. The method according to claim 16, wherein the overall risk score determination of step (iv) further involves parsing the raw transaction metadata and the transaction insights metadata against at least one risk rule set by the asset owner, said at least one risk rule including at least one of: permissible IP range, geo-location, and default language of viewer.

18. The method according to claim 17, wherein in transaction insights metadata includes at least one of: network, geolocation associated with the raw metadata IP address, VPN list, proxy server list, and device language.

19. The method according to claim 10, wherein the raw transaction metadata includes at least one of: network name, network type, geolocation, device type, and device default language.

20. An auto-lock apparatus for facilitating automated file access locking based on risk signals, said apparatus comprising:
a receiving module configured to receive raw transaction metadata from document applications;
a transmitting module configured to transmit the received raw transaction metadata to a data risk and eavesdropping analyzer application;
a risk receipt module configured to receive risk metadata from the data risk and eavesdropping analyzer application; and
an instructions module configured to transmit end user access denial instructions upon determination of a high-risk level based on the risk metadata.

21. The auto-lock apparatus according to claim 20, wherein the auto-lock apparatus and at least one document application form a system communicatively coupled to the external data risk and eavesdropping analyzer application.

22. The auto-lock system according to claim 20, wherein the auto-lock apparatus and the data risk and eavesdropping analyzer application form a system communicatively connected to at least one external document application.

23. The auto-lock apparatus according to claim 20, wherein the auto-lock apparatus is further configured to:
record at least one of: the page identifier and the time of viewing that page, and generate a report based on the at least one recorded metric.
